(19) United States
(12) Patent Application Publication
(10) Pub. No.: US 2024/0218217 A1
(43) Pub. Date: Jul. 4, 2024

(54) THERMOSETTING RESIN COMPOSITION AND INSULATING ADHESIVE FILM THEREOF

(71) Applicant: SHENGYI TECHNOLOGY CO., LTD., Dongguan (CN)

(72) Inventors: Jinchao DONG, Dongguan (CN); Naidong SHE, Dongguan (CN); Yanhua ZHANG, Dongguan (CN); Junqi TANG, Dongguan (CN)

(21) Appl. No.: 18/525,254

(22) Filed: Nov. 30, 2023

(30) Foreign Application Priority Data
Dec. 30, 2022 (CN) 202211734990.2

(51) Int. Cl. C09J 163/00; C08K 3/36; C08K 7/18; C08L 63/00; C09J 7/30

(52) U.S. Cl. CPC C09J 163/00; C08K 3/36; C08K 7/18; C08L 63/00; C09J 7/30; C08K 2201/005; C08L 2203/30; C09J 2400/10; C09J 2463/00; C09J 2467/005; C09J 2479/08

(57) ABSTRACT

Thermosetting resin composition and insulating adhesive film. The thermosetting resin composition comprises 30-70 parts of epoxy resin, 5-500 parts of a modified spherical silica powder, and 30-70 parts of a curing agent; the modified spherical silica powder comprises an amino-modified spherical silica powder with a D50 particle size of 0.1-2.0 μm and a coefficient of variation of ≥35% in particle size distribution. By using modified spherical silica powder in epoxy resin system and controlling its D50 particle size and coefficient of variation in particle size distribution, the resin composition can reduce melt viscosity of high-filling system and achieve a low melt viscosity in an insulating adhesive film conducive to the filling of fine circuits. The resin composition for preparation of a build-up adhesive FC-BGA film of a high-filling system has strong bite-etching resistance, low surface roughness after Desmear treatment, high adhesive force with electroless copper and low dielectric loss.

### CROSS-REFERENCE TO RELATED APPLICATIONS

This application claims priority to Chinese Patent Application No. 202211734990.2 filed Dec. 30, 2022, the disclosure of which is incorporated herein by reference in its entirety.

### TECHNICAL FIELD

The present application belongs to the technical field of insulating materials, and relates to a thermosetting resin composition and an insulating adhesive film thereof.

### BACKGROUND

With the development of printed circuit technology, the addition method is favored by board manufacturers because of its extremely low line width/line spacing, which puts forward some requirements for the insulation material: 1. a layer is required to be built on the surface of a manufactured circuit layer, so the insulating adhesive film material is required to have excellent rheological properties to fill the circuit, and thus the insulating adhesive film is required to have a low melt viscosity; 2. because the circuit is very thin, a sufficient adhesive force between the circuit and the adhesive film is required, and the adhesive film is required to have basic characteristics of the addition method to obtain a high adhesive force with copper wire; and 3. due to the requirement of manufacturing fine circuits, the roughness of the roughened adhesive film should not be too large, otherwise it will cause the electroplated copper to penetrate too deeply into the insulating adhesive film, resulting in interlayer insulation failure. To add a filler in the adhesive film can obtain a low thermal expansion coefficient. Filler manufacturers remove the water from the surface of the filler by physical high temperature during the preparation process; however, even after heating at a high temperature of 300° C., it is difficult to completely remove the trace amount of bound water remaining on the surface of the filler, and the presence of such trace bound water will affect the dielectric properties of the low-dielectric loss adhesive film.

Therefore, in this field, it is expected to find an insulating material that can solve the above problems.

### SUMMARY

In view the shortcomings of the prior art, an object of the present application is to provide a thermosetting resin composition and an insulating adhesive film thereof.

To achieve the object, the present application adopts the following technical solutions.

On one hand, the present application provides a thermosetting resin composition, and the thermosetting resin composition comprises the following components by weight:

30-70 parts of an epoxy resin (A), 5-500 parts of a modified spherical silica powder (B) and 30-70 parts of a curing agent (C); the modified spherical silica powder comprises an amino-modified spherical silica powder, and the modified spherical silica powder has a D50 particle size of 0.1-2.0 μm and a coefficient of variation of ≥35% in particle size distribution.

In the present application, by using the modified spherical silica powder in the epoxy resin system and controlling its D50 particle size and coefficient of variation in particle size distribution, the resin composition can solve the problem of high melt viscosity of high filling system and obtain a low melt viscosity when used in an insulating adhesive film, which is conducive to the filling of fine circuits; the resin composition has strong bite-etching resistance, low surface roughness after Desmear treatment, high adhesive force with electroless copper and low dielectric loss, which is suitable for the preparation of a build-up adhesive film for FC-BGA of a high-filling system.

In the thermosetting resin composition of the present application, a usage amount of the epoxy resin can be 30 parts by weight, 35 parts by weight, 38 parts by weight, 40 parts by weight, 45 parts by weight, 50 parts by weight, 55 parts by weight, 60 parts by weight, 65 parts by weight or 70 parts by weight.

In the thermosetting resin composition of the present application, a usage amount of the modified spherical silica powder can be 5 parts by weight, 10 parts by weight, 50 parts by weight, 100 parts by weight, 150 parts by weight, 200 parts by weight, 250 parts by weight, 300 parts by weight, 350 parts by weight, 400 parts by weight, 450 parts by weight or 500 parts by weight.

In the thermosetting resin composition of the present application, a usage amount of the curing agent can be 30 parts by weight, 35 parts by weight, 40 parts by weight, 45 parts by weight, 50 parts by weight, 55 parts by weight, 60 parts by weight, 65 parts by weight or 70 parts by weight.

In the present application, the modified spherical silica powder has a D50 particle size of 0.1-2.0 μm (for example, 0.1 μm, 0.5 μm, 1 μm, 1.3 μm, 1.5 μm, 1.8 μm or 2.0 μm), and a coefficient of variation of ≥35% in particle size distribution (for example, 35%, 40%, 45%, 50%, 55%, 60%, 65% or 70%, etc.). By grading the spherical silica powder, the coefficient of variation in particle size distribution can be adjusted to a specified range of coefficient of variation in particle size distribution and a specified range of particle size D50. When the coefficient of variation in particle size distribution is within this range, the prepared semi-cured insulating adhesive film will have low melt viscosity and good filling ability and good fluidity.

In the present application, if the D50 particle size of the modified spherical silica powder is less than 0.1 μm, the melt viscosity of the prepared semi-cured insulating adhesive film will be greatly increased and the fluidity will be poor; if the D50 particle size of the modified spherical silica powder is more than 2.0 μm, the ability of filling fine circuits will be poor. If the coefficient of variation is less than 35% in particle size distribution, the melt viscosity of the prepared semi-cured insulating adhesive film will be increased. The coefficient of variation, also known as “relative standard deviation”, is a statistical measure of the degree of variation of each particle size in a standard substance. The coefficient of variation of the standard substance in particle size distribution is used to represent a degree of particle size dispersion of the standard substance, which is generally represented as a standard deviation or the percentage of a ratio of standard deviation to the average particle size of the standard substance, and the latter is also known as dispersion. The calculation formula is: Coefficient of variation=Standard deviation/Average particle size, the standard deviation requires to be further calculated by the statistical data of the Malvern particle size distribution, and the average particle size can be substituted with D50. The particle size involved in the present application is tested by laser diffraction method, and a test instrument is Malvern laser particle size analyzer, type MS3000.

Preferably, the amino-modified spherical silica powder comprises a spherical silica powder modified by an amino-silane coupling agent, and a usage amount of the amino-silane coupling agent is 0.1-2% of a weight of the spherical silica powder, for example, 0.1%, 0.3%, 0.5%, 0.8%, 1.0%, 1.3%, 1.5%, 1.8% or 2%.

Preferably, for preparing the amino-modified spherical silica powder, a spherical silica powder is first pretreated with a silazane compound and then modified with an amino-silane coupling agent. Firstly, the pretreatment of spherical silica powder with a silazane compound can completely remove —OH groups (bound water) from the surface of the filler, improve the uniformity of the surface treatment effect of the amino-silane coupling agent, so that the spherical silica powder as an inorganic substance and the resin compound as an organic substance are more uniformly and fully mixed together, which is conducive to reducing the dielectric loss of the insulating adhesive film.

Preferably, the silazane compound is selected from any one or a combination of at least two of hexamethyldisilazane, 1,3-divinyl-1,1,3,3-tetramethyldisilazane, octamethyltrisilazane, hexa(tert-butyl)disilazane, hexabutyldisilazane, hexaoctyldisilazane, 1,3-diethyltetramethyl disilazane, 1,3-di-n-octyltetramethyldisilazane, 1,3-diphenyltetramethyldisilazane, 1,3-dimethyl tetraphenyldisilazane, 1,3-diethyltetramethyldisilazane, 1,1,3,3-tetraphenyl-1,3-dimethyl disilazane, 1,3-dipropyltetramethyldisilazane, hexamethylcyclotrisilazane, hexaphenyldisilazane, dimethylaminotrimethylsilazane, trisilazane, cyclotrisilazane or 1,1,3,3,5,5-hexamethyl cyclotrisilazane.

Preferably, the amino-modified spherical silica powder has a carbon amount of per unit surface area of 0.20-0.50 mg/m², for example, 0.20 mg/m², 0.30 mg/m², 0.35 mg/m², 0.4 mg/m², 0.45 mg/m² or 0.50 mg/m². Too much carbon amount will cause a decrease in build-up layer stability, reliability and environmental resistance of the adhesive film, and too less carbon amount will cause a decrease in the adhesive force between the spherical silica powder as an inorganic substance and the resin compound as an organic substance, which destroys the enclosing effect of resin on the filler.

In the present application, the degree of surface treatment with a surface treatment agent can be evaluated by the carbon amount of per unit surface area. The carbon amount of per unit surface area of the amino-modified spherical silica powder can be measured by the following method: washing an amino-modified spherical silica powder after surface treatment with methyl ethyl ketone, and then performing measurement. Specifically, the process includes adding 30 g of methyl ethyl ketone into 15 g of an amino-modified spherical silica powder after surface treatment with a surface treatment agent, performing ultrasonic cleaning at 25° C. for 5 min, removing a supernatant, and after drying a solid component, measuring a carbon amount of per unit surface area of 0.3 g amino-modified spherical silica powder with a carbon analyzer. An EMIA-320V made by Horiba Co., LTD can be used as the carbon analyzer.

Preferably, the amino-silane coupling agent is selected from any one or a combination of at least two of N-2-(aminoethyl)-3-aminopropylmethyldimethoxysilane, N-2-(aminoethyl)-3-amino propyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxy silane, N-(vinylbenzyl)-2-aminoethyl-3-aminopropyltrimethoxysilane, aminopropylmethoxy silane or aminopropyltriethoxysilane.

Preferably, the epoxy resin is selected from any one or a combination of at least two of a bisphenol A epoxy resin, a bisphenol F epoxy resin, a linear phenolic epoxy resin, a dicyclopentadiene phenolic epoxy resin, a biphenyl phenolic epoxy resin, an aralkyl phenolic epoxy resin, an aralkyl biphenyl phenolic epoxy resin, an aralkyl naphthol phenolic epoxy resin or a naphthalene epoxy resin.

Preferably, the curing agent is selected from any one or a combination of at least two of an amine curing agent, a cyanate ester resin, active ester, a phenolic resin or an anhydride curing agent.

Preferably, the thermosetting resin composition further comprises a carbodiimide resin.

Preferably, the carbodiimide resin is any one or a combination of two of carbodiimide resins containing an aliphatic structure or an aromatic structure.

Preferably, based on a total weight of the component (A), component (C) and component (D) being 100 parts by weight, a usage amount of the carbodiimide resin is 1-10 parts, for example, 1 parts, 3 parts, 5 parts, 7 parts, 9 parts or 10 parts.

Preferably, the thermosetting resin composition further comprises an other filler (E);

Preferably, the other filler comprises an inorganic filler and/or an organic filler.

Preferably, the inorganic filler is selected from any one or a combination of at least two of crystalline silica, fused silica, spherical silica, hollow silica, a glass powder, aluminum nitride, boron nitride, silicon carbide, aluminum hydroxide, titanium dioxide, strontium titanate, barium titanate, aluminium oxide, barium sulfate, talc, calcium silicate, calcium carbonate or mica.

Preferably, the organic filler is selected from any one or a combination of at least two of a polytetrafluoroethylene powder, polyphenylene sulfide, polyetherimide, polyphenylene ether or a polyethersulfone powder.

Preferably, based on a total weight of the component (A), component (C) and component (D) being 100 parts by weight, a total addition amount of the modified spherical silica powder (B) and the other filler (E) is 5-500 parts, for example, 5 parts by weight, 10 parts by weight, 30 parts by weight, 50 parts by weight, 80 parts by weight, 100 parts by weight, 150 parts by weight, 200 parts by weight, 250 parts by weight, 300 parts by weight, 350 parts by weight, 400 parts by weight, 450 parts by weight or 500 parts by weight.

In the present application, on the premise of not affecting the comprehensive properties of the thermosetting resin composition, a thermoplastic resin can be further added; the thermoplastic resin can be, for example, a polyimide resin, a phenoxy resin, polyphenylene ether, an acrylate resin, a polyvinyl acetal resin, a polyamide imide resin, a polyethersulfone resin, a polysulfone resin or a core-shell rubber, etc.

Preferably, the thermosetting resin composition further comprises a curing accelerator (F).

Preferably, the curing accelerator is selected from any one or a combination of at least two of an organometallic salt compound, an imidazole compound and a derivative thereof, a piperidine compound, or a tertiary amine.

Preferably, the curing accelerator is selected from any one or a mixture of at least two of 2-methylimidazole, 2-phenylimidazole, 2-ethyl-4-methylimidazole, tri-n-butylamine, triphenyl phosphine, a boron trifluoride complex, an octanoate metal salt, an acetylacetonate metal salt, a naphthenate metal salt, a salicylate metal salt or a stearate metal salt, wherein a metal in the salts is selected from any one or a combination of at least two of zinc, copper, iron, tin, cobalt or aluminum.

Preferably, based on a total weight of the component (A), component (C) and component (D) being 100 parts by weight, a usage amount of the curing accelerator (F) is 0.01-1 parts, for example, 0.01 parts by weight, 0.03 parts by weight, 0.05 parts by weight, 0.08 parts by weight, 0.1 parts by weight, 0.3 parts by weight, 0.5 parts by weight, 0.8 parts by weight or 1 part by weight.

On the other hand, the present application provides a resin varnish, and the resin varnish comprises the thermosetting resin composition as described above and a solvent.

Preferably, the solvent is selected from any one or a combination of at least two of acetone, butanone, methyl ethyl ketone, cyclohexanone, toluene or xylene.

On the other hand, the present application provides an insulating adhesive film, and the insulating adhesive film comprises the thermosetting resin composition as described above.

In the present application, a method for preparing the insulating adhesive film comprises the following steps: mixing a thermosetting resin composition with a solvent to obtain a resin varnish, and coating the resin varnish liquid on a base material, baking, and removing the base material to obtain the insulating adhesive film.

Preferably, the base material is any one of a PET release film, a polyethylene film, a polypropylene film or a polyvinyl chloride film.

Preferably, the base material has a thickness of 10-150 μm, for example, 10 μm, 20 μm, 30 μm, 50 μm, 80 μm, 100 μm, 110 μm, 120 μm, 130 μm, 140 μm or 150 μm, further preferably 20-60 μm.

Preferably, the baking is performed at 80-120° ° C., for example, 80° C., 90° C., 100° C., 110° C. or 120° C.

Preferably, the baking is performed for 1-10 min, for example, 1 min, 3 min, 5 min, 8 min or 10 min.

Preferably, the insulating adhesive film has a thickness of 10-100 μm, for example, 10 μm, 30 μm, 50 μm, 80 μm or 100 μm.

Preferably, the insulating adhesive film has a melt viscosity of 500-2100 Pa·s, for example, 500 Pa·s, 600 Pa·s, 700 Pa·s, 800 Pa·s, 900 Pa·s, 1000 Pa·s, 1200 Pa·s, 1500 Pa·s, 1800 Pa·s, 2000 Pa·s or 2100 Pa·s.

Preferably, the insulating adhesive film has a dielectric loss of ≤0.0182 after being cured, for example, 0.0112, 0.0129, 0.0131, 0.0133, 0.0134, 0.0136, 0.0166, 0.0176 or 0.0182.

Preferably, the insulating adhesive film after Desmear treatment has a surface roughness Ra value of ≤0.360 μm (for example, 0.36 μm, 0.35 μm, 0.32 μm, 0.31 μm, 0.29 μm, 0.28 μm, 0.27 μm, 0.25 μm or 0.22 μm), and an adhesive force of ≥5.7 N/cm with electroless copper (for example, 5.70 N/cm, 6.10 N/cm, 6.40 N/cm, 6.50 N/cm, 6.60 N/cm, 7.10 N/cm, 7.90 N/cm, or 8.10 N/cm).

The insulating adhesive film of the present application is applied to a semi-addition method or an addition method to prepare a circuit, which is applied in the usage scenario of FC-BGA (Flip Chip Ball Grid Array). The insulating adhesive film, after bite-etched, has both low surface roughness and high electroless copper adhesion, solving the technical problem that low surface roughness and high copper foil peel strength are hard to hold concurrently which have long plagued this field.

Compared with the prior art, the beneficial effects of the present application are as follows.

In the present application, by using the modified spherical silica powder in the epoxy resin system and controlling its D50 particle size and coefficient of variation in particle size distribution, the resin composition can solve the problem of high melt viscosity of high filling system and obtain a low melt viscosity when used in an insulating adhesive film, which is conducive to the filling of fine circuits; the resin composition has strong bite-etching resistance, low surface roughness after Desmear treatment, high adhesive force with electroless copper and low dielectric loss, which is suitable for the preparation of a build-up adhesive film for FC-BGA of a high-filling system.

### DETAILED DESCRIPTION

The technical solutions of the present application are further explained by the following embodiments. It should be understood by those skilled in the art that the examples are merely intended to facilitate the understanding of the present application and should not be regarded as specific limitations of the present application.

Information of modified spherical silica powder used in examples and comparative examples are as follows.

Modified spherical silica powder 1: 100 parts by weight of a spherical silica powder is placed in a blender, a vaporized amino-silane coupling agent (0.2 parts by weight, 3-aminopropyltrimethoxysilane, KBM-903, Shin-Etsu Chemical) is sprayed while the spherical silica powder is stirred, and reacted for 10 min to obtain an amino-modified pretreated spherical silica powder. The modified spherical silica powder 1 has a D50 of 0.5 μm and a coefficient of variation of 50% in particle size distribution.

Modified spherical silica powder 2: 100 parts by weight of a spherical silica powder is placed in a blender, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 2 has a D50 of 0.5 μm and a coefficient of variation of 50% in particle size distribution.

Modified spherical silica powder 3: 100 parts by weight of a spherical silica powder is placed in a blender, a vaporized silazane compound (0.2 parts by weight, hexamethyldisilazane, SZ-31, Shin-Etsu Chemical) is sprayed while the spherical silica powder is stirred, and reacted for 10 min to obtain an silazane-pretreated spherical silica powder; then, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 3 has a D50 of 0.5 μm and a coefficient of variation of 50% in particle size distribution.

Modified spherical silica powder 4: 100 parts by weight of a spherical silica powder is placed in a blender, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 4 has a D50 of 0.7 μm and a coefficient of variation of 50% in particle size distribution.

Modified spherical silica powder 5: 100 parts by weight of a spherical silica powder is placed in a blender, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 5 has a D50 of 1.0 μm and a coefficient of variation of 50% in particle size distribution.

Modified spherical silica powder 6: 100 parts by weight of a spherical silica powder is placed in a blender, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 6 has a D50 of 0.5 μm and a coefficient of variation of 40% in particle size distribution.

Modified spherical silica powder 7: 100 parts by weight of a spherical silica powder is placed in a blender, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 7 has a D50 of 0.5 μm and a coefficient of variation of 60% in particle size distribution.

Modified spherical silica powder 8: 100 parts by weight of a spherical silica powder is placed in a blender, a vaporized amino-silane coupling agent (0.4 parts by weight, vinyltrimethoxysilane, KBM-1003, Shin-Etsu Chemical) is sprayed while the spherical silica powder is stirred, and reacted for 10 min to obtain an amino-modified pretreated spherical silica powder. The modified spherical silica powder 8 has a D50 of 0.5 μm and a coefficient of variation of 40% in particle size distribution.

Modified spherical silica powder 9: 100 parts by weight of a spherical silica powder is placed in a blender, a vaporized amino-silane coupling agent (0.4 parts by weight, 3-glycidoxypropyltrimethoxysilane, KBM-403, Shin-Etsu Chemical) is sprayed while the spherical silica powder is stirred, and reacted for 10 min to obtain an amino-modified pretreated spherical silica powder. The modified spherical silica powder 9 has a D50 of 0.5 μm and a coefficient of variation of 40% in particle size distribution.

Modified spherical silica powder 10: 100 parts by weight of a spherical silica powder is placed in a blender, a vaporized amino-silane coupling agent (0.4 parts by weight, 3-methacryloxypropyltrimethoxysilane, KBM-503, Shin-Etsu Chemical) is sprayed while the spherical silica powder is stirred, and reacted for 10 min to obtain an amino-modified pretreated spherical silica powder. The modified spherical silica powder 10 has a D50 of 0.5 μm and a coefficient of variation of 40% in particle size distribution.

Modified spherical silica powder 11: 100 parts by weight of a spherical silica powder is placed in a blender, a vaporized amino-silane coupling agent (0.4 parts by weight, N-phenyl-3-aminopropyltrimethoxysilane, KBM-573, Shin-Etsu Chemical) is sprayed while the spherical silica powder is stirred, and reacted for 10 min to obtain an amino-modified pretreated spherical silica powder. The modified spherical silica powder 11 has a D50 of 0.5 μm and a coefficient of variation of 20% in particle size distribution.

### Example 1

45 parts by weight of an epoxy resin (NC-3000-H, Nippon Kayaku), 50 parts by weight of a phenolic resin (MEH-7851H, Meiwa Kasei), 100 parts by weight of a modified spherical silica powder 1, 5 parts by weight of a carbodiimide resin (HMV-10B, Nisshinbo), 10 parts by weight of an other filler (spherical silica, SC-2050 MB, Admatechs) and 0.1 parts by weight of a curing accelerator (2E4MZ) were added into a butanone solvent and stirred for 2 h to form a resin varnish with a solid content of 65%. The resin varnish was coated on a PET release film and baked in an oven at 120° ° C. for 5 min to obtain an insulating adhesive film.

Components of the thermosetting resin composition in Examples 2-12 and Comparative Examples 1˜4 are shown in Tables 1-3, wherein usage amounts of the components are measured in parts by weight.

TABLE 1

| | | Example | Example | Example | Example | Example | Example |
|---|---|---|---|---|---|---|---|
| Material/related property | | 1 | 2 | 3 | 4 | 5 | 6 |
| Epoxy resin (A) | NC-3000-H | 45 | | | | | |
| | (Nippon Kayaku) | | | | | | |
| | ESN-475V (Nippon Steel) | | 70 | | | | |
| | YX7700 (Mitsubishi | | | 30 | | | |
| | Chemical) | | | | | | |
| | HP-6000 (Japan DIC) | | | | 45 | 45 | 45 |
| Modified | Modified spherical silica | 100 | 100 | 100 | 100 | | |
| spherical silica | powder 1 | | | | | | |
| powder (B) | Modified spherical silica | | | | | 100 | |
| | powder 2 | | | | | | |
| | Modified spherical silica | | | | | | 100 |
| | powder 3 | | | | | | |
| | Modified spherical silica | | | | | | |
| | powder 4 | | | | | | |
| | Modified spherical silica | | | | | | |
| | powder 5 | | | | | | |
| | Modified spherical silica | | | | | | |
| | powder 6 | | | | | | |
| | Modified spherical silica | | | | | | |
| | powder 7 | | | | | | |
| | Modified spherical silica | | | | | | |
| | powder 8 | | | | | | |
| | Modified spherical silica | | | | | | |
| | powder 9 | | | | | | |
| | Modified spherical silica | | | | | | |
| | powder 10 | | | | | | |
| | Modified spherical silica | | | | | | |
| | powder 11 | | | | | | |
| Curing agent | MEH-7851H (Meiwa Kasei) | 50 | 30 | 70 | | | |
| (C) | CE01PS (Techia New | | | | 55 | 55 | 55 |
| | Material) | | | | | | |
| Carbodiimide | HMV-10B (Nisshinbo) | 5 | | | | | |
| resin (D) | | | | | | | |
| Other filler (E) | SC-2050MB (Admatechs) | 10 | | | | | |
| Curing | 2E4MZ | 0.1 | 0.1 | 0.1 | | | |
| accelerator (F) | C-6522 | | | | 0.02 | 0.02 | 0.02 |
| Assessment | Minimum melt viscosity | 2000 | 1500 | 2100 | 1700 | 1100 | 800 |
| result | (Pa · s) | | | | | | |
| | Ra (after Desmearm | 0.32 | 0.35 | 0.25 | 0.29 | 0.27 | 0.28 |
| | treatment) (μm) | | | | | | |
| | Adhesive force with | 8.10 | 7.90 | 7.10 | 6.50 | 6.40 | 6.50 |
| | electroless copper (N/cm) | | | | | | |
| | Df (10 GHz SPDR method) | 0.0166 | 0.0182 | 0.0176 | 0.0131 | 0.0134 | 0.0112 |

TABLE 2

| | | Example | Example | Example | Example | Example | Example |
|---|---|---|---|---|---|---|---|
| Material/related property | | 7 | 8 | 9 | 10 | 11 | 12 |
| Epoxy resin (A) | NC-3000-H | | | | | | |
| | (Nippon Kayaku) | | | | | | |
| | ESN-475V (Nippon Steel) | | | | | | |
| | YX7700 (Mitsubishi | | | | | | |
| | Chemical) | | | | | | |
| | HP-6000 (Japan DIC) | 45 | 45 | 45 | 45 | 45 | 45 |
| Modified | Modified spherical silica | | | | | | |
| spherical silica | powder 1 | | | | | | |
| powder (B) | Modified spherical silica | | | | | 50 | 150 |
| | powder 2 | | | | | | |
| | Modified spherical silica | | | | | | |
| | powder 3 | | | | | | |
| | Modified spherical silica | 100 | | | | | |
| | powder 4 | | | | | | |
| | Modified spherical silica | | 100 | | | | |
| | powder 5 | | | | | | |
| | Modified spherical silica | | | 100 | | | |
| | powder 6 | | | | | | |
| | Modified spherical silica | | | | 100 | | |
| | powder 7 | | | | | | |
| | Modified spherical silica | | | | | | |
| | powder 8 | | | | | | |
| | Modified spherical silica | | | | | | |
| | powder 9 | | | | | | |
| | Modified spherical silica | | | | | | |
| | powder 10 | | | | | | |
| | Modified spherical silica | | | | | | |
| | powder 11 | | | | | | |
| Curing agent | MEH-7851H (Meiwa Kasei) | | | | | | |
| (C) | CE01PS (Techia New | 55 | 55 | 55 | 55 | 55 | 55 |
| | Material) | | | | | | |
| Carbodiimide | HMV-10B (Nisshinbo) | | | | | | |
| resin (D) | | | | | | | |
| Other filler (E) | SC-2050MB (Admatechs) | | | | | | |
| Curing | 2E4MZ | | | | | | |
| Accelerator (F) | C-6522 | 0.02 | 0.02 | 0.02 | 0.02 | 0.02 | 0.02 |
| Assessment | Minimum melt viscosity | 650 | 500 | 1300 | 700 | 550 | 1900 |
| result | (Pa · s) | | | | | | |
| | Ra (after Desmearm | 0.32 | 0.36 | 0.22 | 0.31 | 0.33 | 0.25 |
| | treatment) (μm) | | | | | | |
| | Adhesive force with | 6.50 | 6.50 | 6.10 | 6.60 | 6.90 | 5.70 |
| | electroless copper (N/cm) | | | | | | |
| | Df (10 GHz SPDR method) | 0.0133 | 0.0133 | 0.0129 | 0.0136 | 0.0151 | 0.0122 |

TABLE 3

| | | Comparative | Comparative | Comparative | Comparative |
|---|---|---|---|---|---|
| | | Example | Example | Example | Example |
| Material/related property | | 1 | 2 | 3 | 4 |
| Epoxy | NC-3000-H (Nippon Kayaku) | | | | |
| resin (A) | ESN-475V (Nippon Steel) | | | | |
| | YX7700 (Mitsubishi | | | | |
| | Chemical) | | | | |
| | HP-6000 (Japan DIC) | 45 | 45 | 45 | 45 |
| Modified | Modified spherical silica | | | | |
| spherical silica | powder 1 | | | | |
| powder (B) | Modified spherical silica | | | | |
| | powder 2 | | | | |
| | Modified spherical silica | | | | |
| | powder 3 | | | | |
| | Modified spherical silica | | | | |
| | powder 4 | | | | |
| | Modified spherical silica | | | | |
| | powder 5 | | | | |
| | Modified spherical silica | | | | |
| | powder 6 | | | | |
| | Modified spherical silica | | | | |
| | powder 7 | | | | |
| | Modified spherical silica | 100 | | | |
| | powder 8 | | | | |
| | Modified spherical silica | | 100 | | |
| | powder 9 | | | | |
| | Modified spherical silica | | | 100 | |
| | powder 10 | | | | |
| | Modified spherical silica | | | | 100 |
| | powder 11 | | | | |
| Curing agent | MEH-7851H (Meiwa Kasei) | | | | |
| (C) | CE01PS (Techia New | 55 | 55 | 55 | 55 |
| | Material) | | | | |
| Carbodiimide | HMV-10B (Nisshinbo) | | | | |
| resin (D) | | | | | |
| Other filler (E) | SC-2050MB (Admatechs) | | | | |
| Curing | 2E4MZ | | | | |
| Accelerator (F) | C-6522 | 0.02 | 0.02 | 0.02 | 0.02 |
| Assessment | Minimum melt viscosity | 2300 | 1200 | 2600 | 3600 |
| result | (Pa · s) | | | | |
| | Ra (after Desmearm treatment) | 0.53 | 0.49 | 0.59 | 0.23 |
| | (μm) | | | | |
| | Adhesive force with | 1.30 | 2.70 | 1.60 | 6.4 |
| | electroless copper (N/cm) | | | | |
| | Df (10 GHz SPDR method) | 0.0130 | 0.0132 | 0.0130 | 0.0128 |

The obtained insulating adhesive films are subjected to performance tests, and the test methods are as follows.

### Minimum Melt Viscosity

350 mg of an insulating adhesive film at semi-cured state is taken as a sample, ground into a powder and tested with an oscillatory rheometer, where the test is performed at 40-180° C. with a heating rate of 3° C./min; an abscissa of the obtained test curve is temperature, and an ordinate is melt viscosity; the bottommost melt viscosity point is taken and read for its value with a unit of Pa·s.

### Dielectric Loss Tangent (D_{f})

A fully cured insulating adhesive film sample with a length of 80 mm, a width of 80 mm and a thickness of 40 μm is taken, fixed on an Agilent Impedance/Material Analyzer with an Agilent 16453A measuring fixture, and subjected to scan test to measure a dielectric loss tangent at 1 GHz.

### Arithmetic Mean of Roughness Profile (Ra)

The insulating adhesive film is pressed on the surface of a core board, cured in an oven at 180° C. for 30 min to obtain a pre-cured insulating adhesive film, and the insulating adhesive film is subjected to the following Desmear treatment: soaked in an aqueous solution of glycol ethers and sodium hydroxide (MV Sweller, ATOTECH) at 70° C. for 10 min—washed with deionized water for 2 min—soaked in a potassium permanganate solution (MV P-Etch, ATOTECH) at 80° C. for 30 min—washed with deionized water for 2 min—soaked in an acidic aqueous solution (MV Reduction Cleaner, ATOTECH) at 50° C. for 5 min to obtain the roughened insulating adhesive film, and a surface Ra after roughening treatment is tested with a laser confocal instrument (OLYMPUS).

### Adhesive Force of Electroless Copper (PS)

The above roughened insulating adhesive film is subjected to the following copper precipitation, electroplating and post-curing treatment: soaked in a electroless copper liquid (MV TP1, ATOTECH) for 20 min—electroplated with copper with a thickness of 25 μm—cured in an oven at 200° C. for 60 min, and an adhesive force of electroless copper of the insulating adhesive film is tested with a copper foil peel strength tester.

As can be seen from Tables 1-3, the insulating adhesive films in Examples 1-12 of the present application have the minimum melt viscosity of 500-2100 Pa·s, the surface roughness Ra value after Desmear treatment of 0.22-0.36 μm, the adhesive force with electroless copper of 5.7-8.1 N/cm and the dielectric loss of 0.0112-0.0182. Compared with Example 5, the modified spherical silica powder in Example 6 is pretreated with the silazane compound, and the —OH groups (bound water) from the surface of the filler are completely removed, which improves the uniformity of the surface treatment effect of the coupling agent, and the insulating adhesive film obtains lower dielectric loss.

In Comparative Examples 1-3, for the insulating adhesive films prepared from the spherical silica powder respectively modified by the vinyl, epoxy or methylpropenyl silane coupling agents, their minimum melt viscosity is mediocre, and the surface roughness Ra value after Desmear treatment is significantly increased but not conducive to improving the adhesive force with electroless copper, and the electroplated copper penetrates too deeply into the insulating adhesive film, causing latent risks on the long-term interlayer insulation reliability. The coefficient of variation in particle size distribution of the modified spherical silica powder used in Comparative Example 4 is only 20%, and the minimum melt viscosity of the prepared insulating adhesive film is too high, which is not conducive to the filling of fine circuit.

The applicant declares that the present application illustrates the thermosetting resin composition and the insulating adhesive film thereof in the present application in terms of the above examples, but the present application is not limited to the above examples, which means that the present application is not necessarily rely on the above examples to be implemented. Those skilled in the art should understand that any improvement of the present application, the equivalent substitution of each raw material of the product and the addition of auxiliary ingredients, the selection of specific methods in the present application shall fall within the scope of protection and disclosure of the present application.

What is claimed is:

1. A thermosetting resin composition, comprising the following components by weight:
30-70 parts of an epoxy resin (A), 5-500 parts of a modified spherical silica powder (B) and 30-70 parts of a curing agent (C); the modified spherical silica powder comprises an amino-modified spherical silica powder, and the modified spherical silica powder has a D50 particle size of 0.1-2.0 μm and a coefficient of variation of ≥35% in particle size distribution.

2. The thermosetting resin composition according to claim 1, wherein the amino-modified spherical silica powder comprises a spherical silica powder modified by an amino-silane coupling agent, and a usage amount of the amino-silane coupling agent is 0.1-2% of a weight of the spherical silica powder.

3. The thermosetting resin composition according to claim 1, wherein for preparing the amino-modified spherical silica powder, a spherical silica powder is first pretreated with a silazane compound and then modified with an amino-silane coupling agent.

4. The thermosetting resin composition according to claim 3, wherein the silazane compound is selected from any one or a combination of at least two of hexamethyldisilazane, 1,3-divinyl-1,1,3,3-tetramethyldisilazane, octamethyltrisilazane, hexa(tert-butyl)disilazane, hexabutyldisilazane, hexaoctyldisilazane, 1,3-diethyltetramethyl disilazane, 1,3-di-n-octyltetramethyldisilazane, 1,3-diphenyltetramethyldisilazane, 1,3-dimethyl tetraphenyldisilazane, 1,3-diethyltetramethyldisilazane, 1,1,3,3-tetraphenyl-1,3-dimethyl disilazane, 1,3-dipropyltetramethyldisilazane, hexamethylcyclotrisilazane, hexaphenyldisilazane, dimethylaminotrimethylsilazane, trisilazane, cyclotrisilazane or 1,1,3,3,5,5-hexamethylcyclo trisilazane.

5. The thermosetting resin composition according to claim 2, wherein the amino-silane coupling agent is selected from any one or a combination of at least two of N-2-(aminoethyl)-3-aminopropylmethyldimethoxysilane, N-2-(aminoethyl)-3-aminopropyl trimethoxysilane, 3-aminopropyltrimethoxysilane, 3-aminopropyltriethoxysilane, 3-triethoxy silyl-N-(1,3-dimethyl-butylidene)propylamine, N-phenyl-3-aminopropyltrimethoxysilane, N-(vinylbenzyl)-2-aminoethyl-3-aminopropyltrimethoxysilane, aminopropylmethoxysilane or aminopropyltriethoxysilane.

6. The thermosetting resin composition according to claim 1, wherein the epoxy resin is selected from any one or a combination of at least two of a bisphenol A epoxy resin, a bisphenol F epoxy resin, a linear phenolic epoxy resin, a dicyclopentadiene phenolic epoxy resin, a biphenyl phenolic epoxy resin, an aralkyl phenolic epoxy resin, an aralkyl biphenyl phenolic epoxy resin, an aralkyl naphthol phenolic epoxy resin or a naphthalene epoxy resin.

7. The thermosetting resin composition according to claim 1, wherein the curing agent is selected from any one or a combination of at least two of an amine curing agent, a cyanate ester resin, active ester, a phenolic resin or an anhydride curing agent.

8. The thermosetting resin composition according to claim 1, wherein the thermosetting resin composition further comprises a carbodiimide resin (D).

9. The thermosetting resin composition according to claim 8, wherein the carbodiimide resin is any one or a combination of two of carbodiimide resins containing an aliphatic structure or an aromatic structure.

10. The thermosetting resin composition according to claim 8, wherein based on a total weight of the component (A), component (C) and component (D) being 100 parts by weight, a usage amount of the carbodiimide resin is 1-10 parts.

11. The thermosetting resin composition according to claim 8, wherein the thermosetting resin composition further comprises an other filler (E).

12. The thermosetting resin composition according to claim 11, wherein the other filler comprises an inorganic filler and/or an organic filler.

13. The thermosetting resin composition according to claim 12, wherein the inorganic filler is selected from any one or a combination of at least two of crystalline silica, fused silica, spherical silica, hollow silica, a glass powder, aluminum nitride, boron nitride, silicon carbide, aluminum hydroxide, titanium dioxide, strontium titanate, barium titanate, aluminium oxide, barium sulfate, talc, calcium silicate, calcium carbonate or mica.

14. The thermosetting resin composition according to claim 12, wherein the organic filler is selected from any one or a combination of at least two of a polytetrafluoroethylene powder, polyphenylene sulfide, polyetherimide, polyphenylene ether or a polyethersulfone powder.

15. The thermosetting resin composition according to claim 11, wherein based on a total weight of the component (A), component (C) and component (D) being 100 parts by weight, a total addition amount of the modified spherical silica powder (B) and the other filler (E) is 5-500 parts.

16. The thermosetting resin composition according to claim 8, wherein the thermosetting resin composition further comprises a curing accelerator (F).

17. The thermosetting resin composition according to claim 16, wherein the curing accelerator is selected from any one or a combination of at least two of an organometallic salt compound, an imidazole compound and a derivative thereof, a piperidine compound, or a tertiary amine.

18. The thermosetting resin composition according to claim 16, wherein based on a total weight of the component (A), component (C) and component (D) being 100 parts by weight, a usage amount of the curing accelerator (F) is 0.01-1 parts.

19. A resin varnish, comprising the thermosetting resin composition according to claim 1 and a solvent.

20. An insulating adhesive film, comprising the thermosetting resin composition according to claim 1.
